(19) United States
(12) Patent Application Publication
(10) Pub. No.: US 2026/0171775 A1
(43) Pub. Date: Jun. 18, 2026

(54) POWER RECEPTACLE DEVICE AND POWER RECEPTACLE BOX

(71) Applicant: Chengli LI, Suzhou (CN)

(72) Inventors: Junwu ZHOU, Suzhou (CN); Hanqin ZHOU, Suzhou (CN)

(73) Assignee: Chengli LI, Suzhou (CN)

(21) Appl. No.: 19/378,101

(22) Filed: Nov. 3, 2025

(30) Foreign Application Priority Data
Dec. 18, 2024 (CN) 202411869013.2

(51) Int. Cl. H02G 3/08; H01R 4/2404; H01R 12/70; H01R 13/35; H01R 13/713; H01R 13/74; H02G 3/12; H02G 3/14; H02G 3/16; H02G 3/18

(52) U.S. Cl. CPC H02G 3/083; H01R 4/2404; H01R 12/7088; H01R 13/35; H01R 13/7135; H01R 13/748; H02G 3/12; H02G 3/14; H02G 3/16; H02G 3/18

(57) ABSTRACT

A receptacle device includes a first shell having a first opening, a power module at least partially disposed in the first shell and configured to provide power output to an electrical device, a first conductor at least partially disposed in the first shell and having its first end coupled to the power module, and an electrical connection module configured to electrically connect the first conductor and a first external cable. The addition of the electrical connection module in the receptacle device simplifies the installation of the power module in a small space, improves installation efficiency and ensures the electrical safety during subsequent use.

### BACKGROUND OF THE INVENTION

The present invention relates to the electrical field, and in particular to a power receptacle device and a power receptacle box.

With technological advancements and increased safety awareness, power receptacles (or simply referred to as receptacles) with electrical fault circuit interrupters are finding wider application. Furthermore, with the increasing popularity of mobile applications like recreational vehicles (RVs) and outdoor equipment, the need for quick and easy installation is becoming increasingly apparent.

Existing receptacle devices with electrical fault circuit interrupters usually include a combination of multiple components, such as a wall box, a height-extension panel, an electrical fault circuit interrupter, a positioner, and a faceplate. Because these parts are often shipped separately by the manufacturers, the user's installation process is usually cumbersome, time consuming and inefficient. When connecting the power module, it is usually necessary to manually peel off the cable insulation layer to connect the terminal, which is inconvenient and also carries the risk of poor cable contact. In addition, when installing in an RV or a small space, the operating space is limited, but the wiring terminals require precise wire connection operations, and if the wiring is insecurely or improperly installed, it can cause electrical failures, affecting the service life of the equipment and the user's electrical safety.

### SUMMARY OF THE INVENTION

Therefore, there is an urgent need for a receptacle device that integrates a power module and an electrical connection module to reduce the components required by the user during installation, which will simplify the entire installation process, improve the user's installation efficiency and ensure the user's electrical safety during subsequent use.

In order to solve the above problems and defects in conventional technology, an object of the present invention is to provide a receptacle device that integrates a power module and an electrical connection module.

Based on the above, in one aspect, the present invention provides a receptacle device, which includes: a first shell, having a first opening; a power module, at least partially disposed in the first shell and configured to provide power output to an electrical device; a first conductor, at least partially disposed in the first shell, wherein a first end of the first conductor is coupled to the power module; and an electrical connection module configured to electrically connect the first conductor and a first external cable.

In one embodiment, the electrical connection module includes a second shell coupled to the first shell, the second shell having a second opening.

In one embodiment, the electrical connection module further includes: a bracket assembly, at least partially disposed in the second shell; and a piercing terminal assembly, disposed on the bracket assembly and configured to electrically connect the first conductor and the first external cable.

In one embodiment, the piercing terminal assembly includes a receiving slot configured to receive and pierce a second end of the first conductor and a first end of the first external cable to form an electrical connection between the first conductor and the first external cable.

In one embodiment, the receptacle device further includes: a cover plate, which covers the second opening of the second shell and is configured to press the second end of the first conductor and the first end of the first external cable into the receiving slot of the piercing terminal assembly in response to an external force, so that the piercing terminal assembly pierces the second end of the first conductor and the first end of the first external cable.

In one embodiment, the piercing terminal assembly includes a receiving slot integrally formed with the first conductor, wherein the receiving slot is configured to receive and pierce a first end of the first external cable so that the first conductor and the first external cable form an electrical connection.

In one embodiment, the receptacle device further includes: a cover plate, which covers the second opening of the second shell and is configured to press the first end of the first external cable into the receiving slot of the piercing terminal assembly in response to an external force, so that the piercing terminal assembly pierces the first end of the first external cable.

In one embodiment, the bracket assembly includes a plurality of grooves, and the piercing terminal assembly includes a plurality of piercing terminals, which are respectively inserted into the plurality of grooves.

In one embodiment, the electrical connection module further includes: a circuit board assembly, at least partially disposed in the second shell, configured to electrically connect the first conductor and the first external cable.

In one embodiment, the circuit board assembly includes a circuit board and a wiring terminal block disposed on the circuit board, wherein a second end of the first conductor is coupled to the circuit board; wherein a first end of the wiring terminal block is coupled to the circuit board, and a second end of the wiring terminal block is coupled to a first end of the first external cable.

In one embodiment, the power module includes an electrical fault circuit interrupter, wherein the first end of the first conductor is coupled to an input terminal of the electrical fault circuit interrupter.

In one embodiment, the receptacle device further includes: a second conductor at least partially disposed within the first shell, wherein a first end of the second conductor is coupled to a load terminal of the electrical fault circuit interrupter, wherein the electrical connection module is further configured to receive a second end of the second conductor and a first end of a second external cable, to electrically connect the second conductor and the second external cable.

In one embodiment, the second shell has a first through hole and a second through hole, wherein the first through hole is configured to allow the first end of the first external cable to pass through and enter the second shell, and the second through hole is configured to allow the first end of the second external cable to pass through and enter the second shell.

In one embodiment, the receptacle device further includes a panel covering the first opening of the first shell.

In one embodiment, the receptacle device further includes: a fixing assembly, disposed on the first shell and configured to affix the receptacle device to a target object when the receptacle device is mounted on the target object.

In one embodiment, each of the first conductor and the first external cable include a hot wire, a neutral wire, and a ground wire.

In another aspect, the present invention provides a receptacle box, which includes: a first shell having a first opening, the first shell being configured to at least partially accommodate a power module and a first conductor, wherein a first end of the first conductor is coupled to the power module, and the power module is configured to provide power to an electrical device; and an electrical connection module, configured to connect the first conductor to a first external cable.

In one embodiment, the electrical connection module includes: a second shell coupled to the first shell, the second shell having a second opening; a bracket assembly at least partially disposed within the second shell; and a piercing terminal assembly disposed on the bracket assembly, configured to connect the first conductor and the first external cable.

In the aforementioned exemplary embodiments of the present invention, compared with conventional technology, the height-extension panel is omitted, and a new electrical connection module is added to the receptacle device to simplify the installation process of the power module in a small space, thereby improving the user's installation efficiency and ensuring the user's electrical safety during subsequent use.

### BRIEF DESCRIPTION OF DRAWINGS

The features, advantages and other aspects of the various embodiments of the present invention will become more apparent with reference to the following detailed description in conjunction with the accompanying drawings, in which several embodiments of the present invention are shown in an illustrative and non-limiting manner. In the accompanying drawings:

FIG. 1 schematically illustrates a receptacle device according to an embodiment of the present invention.

FIG. 2 schematically illustrates a receptacle box according to an embodiment of the present invention.

FIG. 3 is an exploded view of a receptacle box according to an embodiment of the present invention.

FIG. 4 is an exploded view of a receptacle device according to an embodiment of the present invention.

FIGS. 5A and 5B are respectively a front view and a back view of a receptacle device after assembly according to an embodiment of the present invention.

FIG. 6 schematically illustrates the installation of a receptacle device according to an embodiment of the present invention.

FIGS. 7A and 7B are respectively a front view and a back view of a receptacle device installed on a wall panel according to an embodiment of the present invention.

FIG. 8 is an exploded view of a receptacle device according to another embodiment of the present invention.

FIG. 9 is an exploded view of a receptacle device according to yet another embodiment of the present invention.

### DETAILED DESCRIPTION OF THE INVENTION

Embodiments of the present invention are described in detail below with reference to the drawings. In the specification and drawings, like features are designated by like reference symbols. The descriptions below should be taken as explanations of the overall inventive concept of the present invention and should not be construed as a limitation on the present invention.

In the descriptions below, terms such as “including” are intended to be open-ended and mean “including without limitation”, and can include other contents. “Based on” means “at least partly based on.” “An embodiment” means “at least one embodiment.” “Another embodiment” means “at least another embodiment,” etc.

Installation of conventional receptacle typically uses a height-extension panel to increase the thickness of the wall box, resulting in a larger installation volume. Users face the challenges of numerous and scattered components, cumbersome installation procedures, and the precise terminal connections required to ensure safety, making installation more challenging in confined spaces and generally resulting in lower installation efficiency.

The receptacle device according to embodiments of the present invention can be applied to any scenario where a receptacle needs to be installed. The advantages are more significant when installing a receptacle with a large power module in a small space, and the installation efficiency is greatly improved. The receptacle device and receptacle box of embodiments of the present invention will be described below with reference to the accompanying drawings.

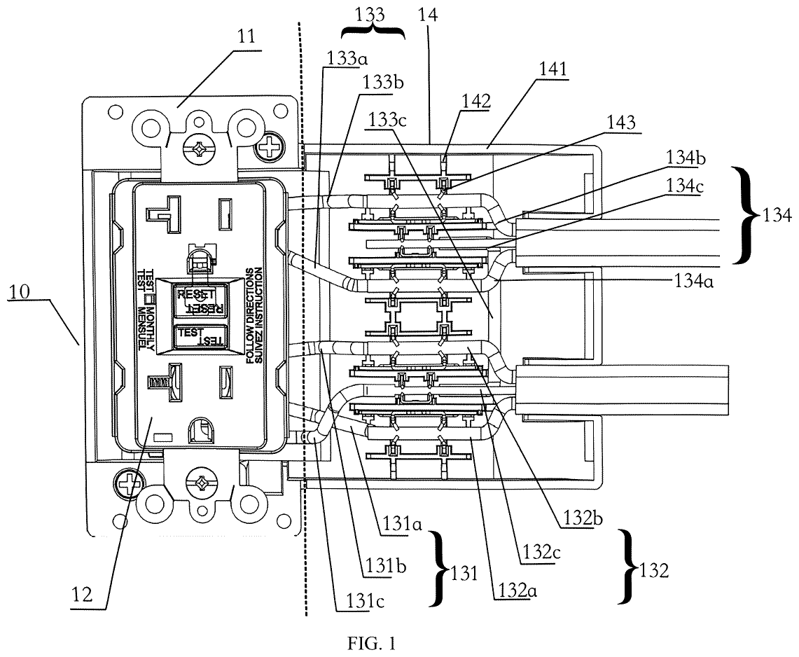

FIG. 1 schematically illustrates a receptacle device according to an embodiment of the present invention. Referring to FIG. 1, the exemplary receptacle device 10 includes a first shell 11, a power module 12, a first conductor 131, and an electrical connection module 14. Both the power module 12 and the first conductor 131 are at least partially disposed within the first shell 11. The power module 12 is configured to provide power output, such as AC and/or DC output, to an electrical device (not shown). In one embodiment, the power module 12 may be an electrical fault circuit interrupter designed to protect circuits and equipment while providing power output. The electrical fault circuit interrupter may be, for example, a ground fault circuit interrupter (GFCI). A GFCI monitors the current difference between the hot and neutral wires in a circuit and instantly cuts off power when the current difference reaches a threshold, ensuring safety of the user. Alternatively, the electrical fault circuit interrupter may be an arc fault circuit interrupter (AFCI).

The electrical connection module 14 is coupled to the first shell 11 and is configured to receive the first conductor 131 and a first external cable 132 which is coupled to the external power supply system, and to electrically connect the first conductor 131 and the first external cable 132. In one embodiment, the first conductor 131 may be input-end connection wires for the power supply module 12, with its first end coupled to input terminals of the power supply module 12 and its second end connected to the first end of the first external cable 132 via the electrical connection module 14, thereby electrically connecting the first conductor 131 and the first external cable 132. The second end of the first external cable 132 may, for example, be coupled to the power supply system of the RV, so that electricity stored within the RV is transmitted to the power supply module 12 via the first conductor 131 electrically connected thereto, thereby providing power to the electrical devices connected to the receptacle device 10.

In one embodiment, the first conductor 131 may include, for example, three sub-cables 131a, 131b, and 131c, which may serve as the hot wire, neutral wire, and ground wire, respectively, as shown in FIG. 1. Accordingly, the input terminals of the power module 12 may include, for example, a hot wire input terminal, a neutral wire input terminal, and a ground wire input terminal. The first external cable 132 may include, for example, three sub-cables 132a, 132b, and 132c, which may similarly serve as the hot wire, neutral wire, and ground wire, respectively, as shown in FIG. 1. The first ends of the three sub-cables 131a, 131b, and 131c of the first conductor 131 are respectively coupled to the hot wire input terminal, the neutral wire input terminal, and the ground wire input terminal of the power module 12, and their second ends are respectively connected to the first ends of the three sub-cables 132a, 132b, and 132c of the first external cable 132 via the electrical connection module 14.

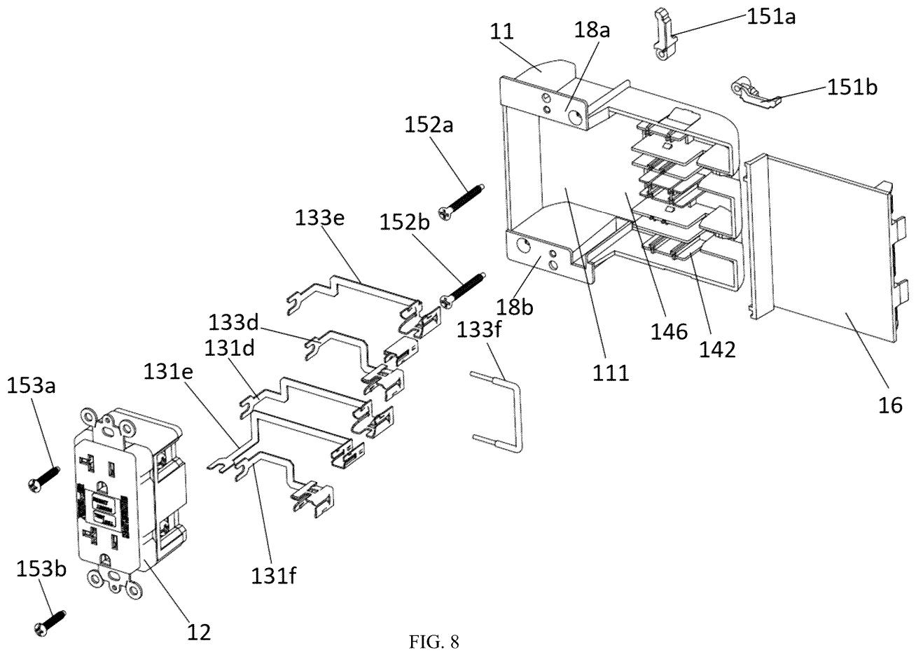

The electrical connection module 14 can be implemented in a variety of ways. In one embodiment, the electrical connection module 14 includes a second shell 141, a bracket assembly 142, and a piercing terminal assembly 143, as shown in FIGS. 1 and 8. The bracket assembly 142 is at least partially disposed within the second shell 141. The piercing terminal assembly 143 is disposed on the bracket assembly 142.

In one embodiment, the first shell 11 and the second shell 141 may be integrally formed. In other embodiments, the second shell 141 and the first shell 11 may be detachable and can be mounted together in a variety of suitable ways, such as snap-fit connection, screw connection, or adhesive connection. In other embodiments, the second shell 141 and the first shell 11 may be separated, that is, a gap may exist between the second shell 141 and the first shell 11. Both the first shell 11 and the second shell 141 may be made of, for example, polycarbonate, or other materials with good electrical insulation, heat resistance, and flame retardancy.

In one embodiment, the bracket assembly 142 and the second shell 141 may be integrally formed. In other embodiments, the bracket assembly 142 and the second shell 141 may be detachable and may be assembled together using various suitable methods, such as snap-fit connections, screw connections, or adhesive connections. The bracket assembly 142 may be made of, for example, polycarbonate, or other materials with good electrical insulation, impact resistance, heat resistance, and flame retardancy.

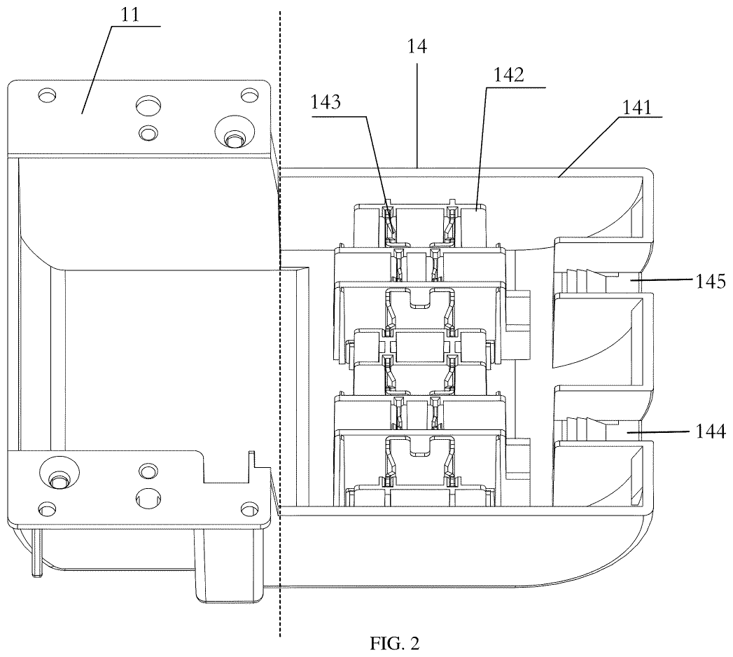

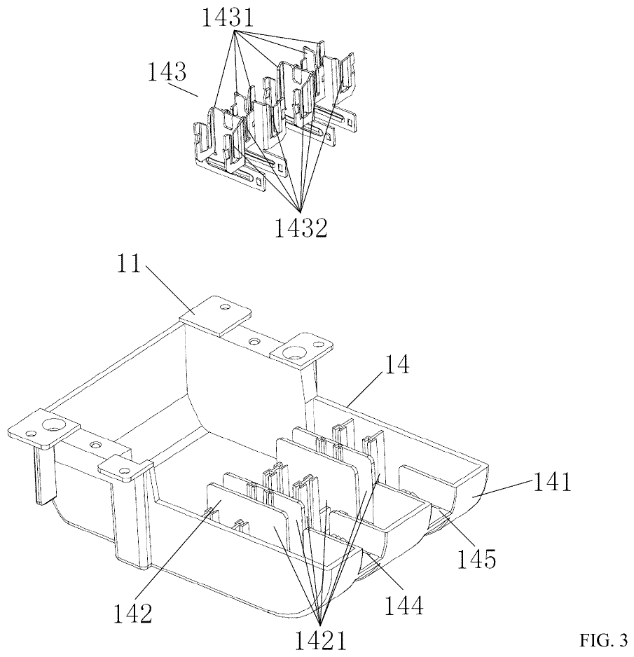

FIG. 2 schematically illustrates a receptacle box according to one embodiment of the present invention; FIG. 3 is an exploded view of the receptacle box. Compared to FIG. 1, the receptacle box does not have the power module, cables, etc. disposed therein. Referring to FIGS. 1 to 3, the piercing terminal assembly 143 includes receiving slots 1432 for accommodating the second end of the first conductor 131 and the first end of the first external cable 132. The receiving slots 1432 are formed with piercing blades for piercing the second end of the first conductor 131 and the first end of the first external cable 132, penetrating the respective insulation layers, thereby establishing an electrical connection between the conductors within the cables and the piercing terminal assembly 143, enabling current transmission. The piercing terminal assembly 143 can replace manual stripping of cable insulation to achieve an electrical connection between the cables and the terminals. The receiving slots 1432 in the piercing terminal assembly 143 may use U-shaped grooves or V-shaped grooves to accommodate and pierce the cables. The piercing terminal assembly 143 may be made of a copper alloy or other materials with good conductivity and wear resistance.

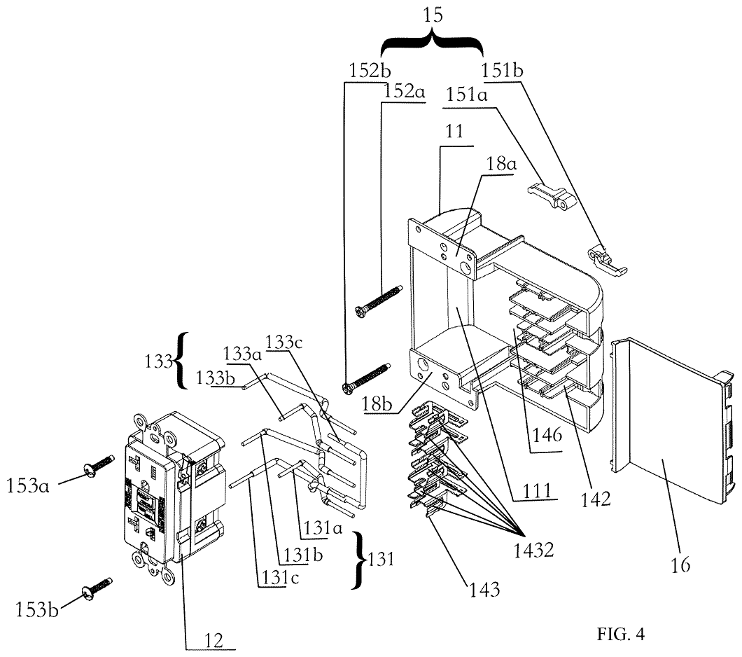

In one embodiment, the bracket assembly 142 may include a plurality of grooves 1421, and the piercing terminal assembly 143 may include a plurality of piercing terminals 1431 (having the piercing blades mentioned above). The plurality of piercing terminals 1431 of the piercing terminal assembly 143 are respectively inserted into the plurality of grooves 1421 of the bracket assembly 142 to maintain the plurality of piercing terminals 1431 in fixed positions, so that the plurality of piercing terminals 1431 can be aligned with the cables that are to be pressed and pierced, and the stability of the piercing terminal assembly 143 during the wiring process is ensured to avoid affecting the quality of the cable connections. As shown in FIGS. 3 and 4, there are two sets of receiving slots 1432 and piercing terminals 1431 on the left and right-hand portions of the piercing terminal assembly 143, and two corresponding sets of grooves 1421 on the bracket assembly 142, for respectively piercing the second end of the first conductor 131 and the first end of the first external cable 132. It should be understood that the method of affixing the piercing terminal assembly 143 to the bracket assembly 142 is not limited to clamping fixation, and other suitable fixing methods, such as adhesive connection fixation, are also applicable.

In other embodiments, the electrical connection device 14 may alternatively use other types of terminals, such as screw-type wiring terminals or quick-connect clamp-type wiring terminals, to achieve electrical connection between the first conductor 131 and the first external cable 132.

Still referring to FIG. 1, in some embodiments, the receptacle device 10 may further include a second conductor 133, which is at least partially disposed within the first shell 11. The second conductor 133 may serve as a load-end connection line for the power module 12. Its first end is coupled to the load terminal of the power module 12, and its second end is electrically connected to the first end of a second external cable 134 via the electrical connection module 14. The second end of the second external cable 134 may be coupled to, for example, a power module of a downstream receptacle or a downstream electrical device, and serve as an output line protected by the power module 12. The second conductor 133 may include, for example, three sub-cables 133a, 133b, and 133c, which may serve as a hot wire, a neutral wire, and a ground wire, respectively, as shown in FIG. 1. Accordingly, the load terminals of the power module 12 may include, for example, a hot load terminal, a neutral load terminal, and a ground load terminal. The ground load terminal and the ground input terminal may be shared; for example, the first end of the sub-cable 133c used as the ground wire in the second conductor 133 may be electrically connected to the second end of the sub-cable 131c used as the ground wire in the first conductor 131 through the electrical connection module 14. The first ends of the sub-cables 133a and 133b used as the hot wire and neutral wire in the second conductor 133 are respectively coupled to the hot load terminal and the neutral load terminal of the power module 12. The second external cable 134 may also include, for example, three sub-cables 134a, 134b, and 134c, which may be used as the hot wire, neutral wire, and ground wire, respectively, as shown in FIG. 1. The first ends of the three sub-cables 134a, 134b, and 134c of the second external cable 134 are respectively connected to the second ends of the three sub-cables 133a, 133b, and 133c of the second conductor 133.

In some embodiments, the second shell 141 of the receptacle device 10 may be provided with through holes, for example, two through holes, namely, a first through hole 144 and a second through hole 145. The first through hole 144 is configured to allow the first end of the first external cable 132 to pass through from outside the receptacle device 10 and into the second shell 141. The second through hole 145 is configured to allow the first end of the second external cable 134 to pass through from outside the receptacle device 10 and into the second shell 141. It will be appreciated that if the receptacle device 10 only includes the first conductor 131, the second through hole 145 may be omitted.

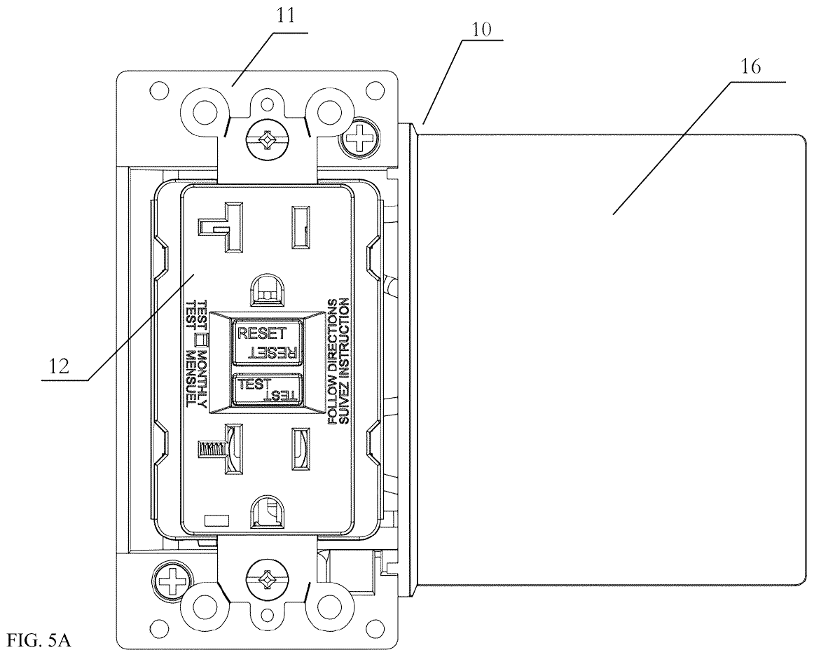

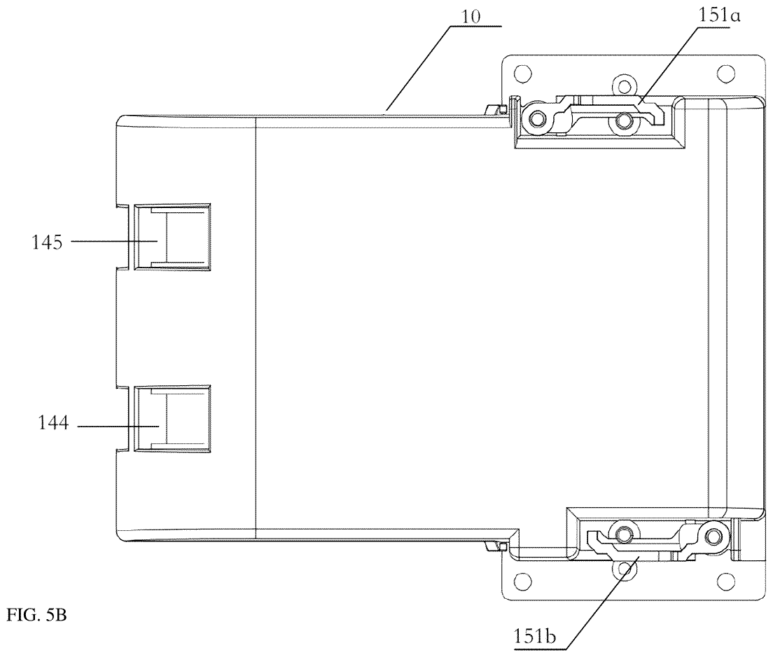

FIG. 4 is an exploded view of a receptacle device according to an embodiment of the present invention; FIGS. 5A and 5B are respectively a front view and a back view of a receptacle device according to an embodiment of the present invention after assembly. Referring to FIGS. 4, 5A and 5B, the receptacle device 10 may further include a fixing assembly 15, which is used to fasten the receptacle device 10 to a target object on which it is to be installed, such as a wall panel inside an RV. In some embodiments, the fixing assembly 15 may include two hooks 151a, 151b and two screws 152a, 152b. It should be understood that the number of hooks and screws is not limited to two. In addition, the fixing assembly 15 is not limited to the form of hooks and screws; it may use other components with a fixing function such as pins, rivets, etc. to fix the receptacle device 10 to the target object.

When assembling the receptacle device 10, the hooks 151a and 151b may be secured to the first shell 11 using the screws 152a and 152b, respectively, for example, secured to a first ear 18a and a second ear 18b of the first shell 11 which extend radially outward from the first opening 111. Further, the piercing terminal assembly 143 is assembled to the bracket assembly 142 by snapping or other means. The first end of the first conductor 131 and the first end of the second conductor 133 are respectively connected to the input (line) terminal and the load terminal of the power module 12, and the power module 12 is secured to the first shell 11 using screws 153a and 153b. The second end of the first conductor 131 and the second end of the second conductor 133 are placed into one set (the one on the left in the figures) of the receiving slots 1432 of the piercing terminal assembly 143, and the cables are pressed in, for example, using a dedicated tool, to form an electrical circuit between the power module 12 and the piercing terminal assembly 143. Finally, the cover 16 is placed over the second opening 146 of the second shell 141 to protect the internal components of the electrical connection module 14 from damage, which reduces the risk of failure due to external interference and improves the safety of the device. The cover 16 may be fastened to the second opening 146 of the second shell 141 using, for example, a snap-fit connection. The cover 16 may be made of, for example, polycarbonate, or other materials with good electrical insulation, impact resistance, heat resistance, and flame retardancy.

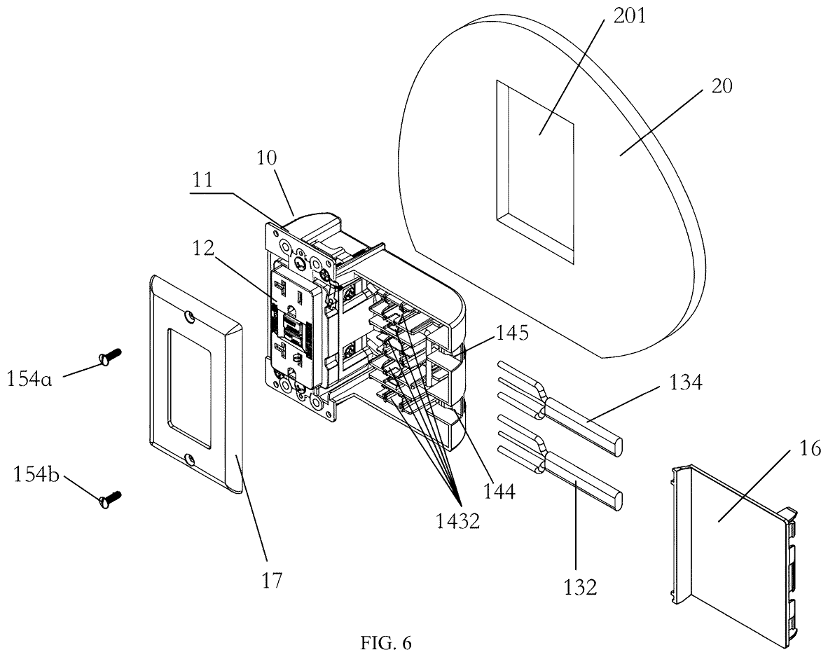

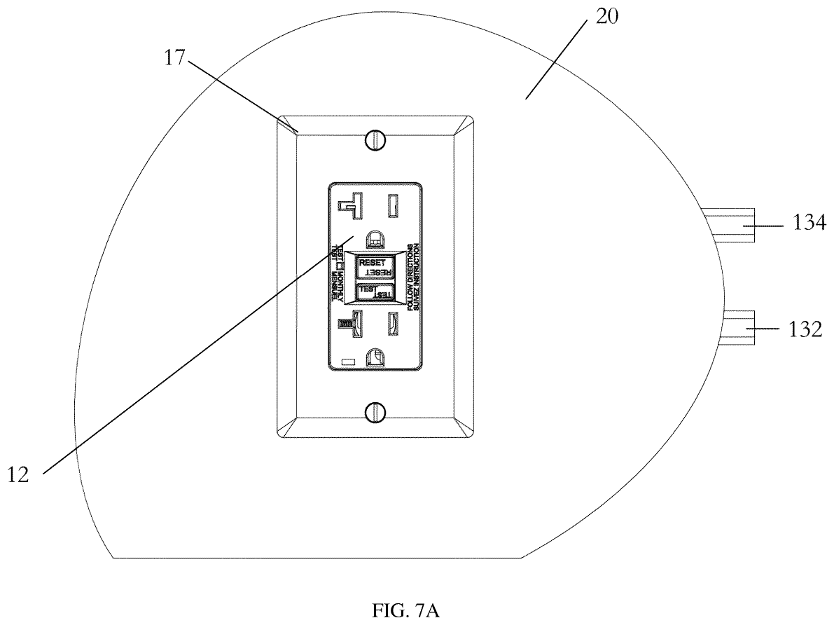

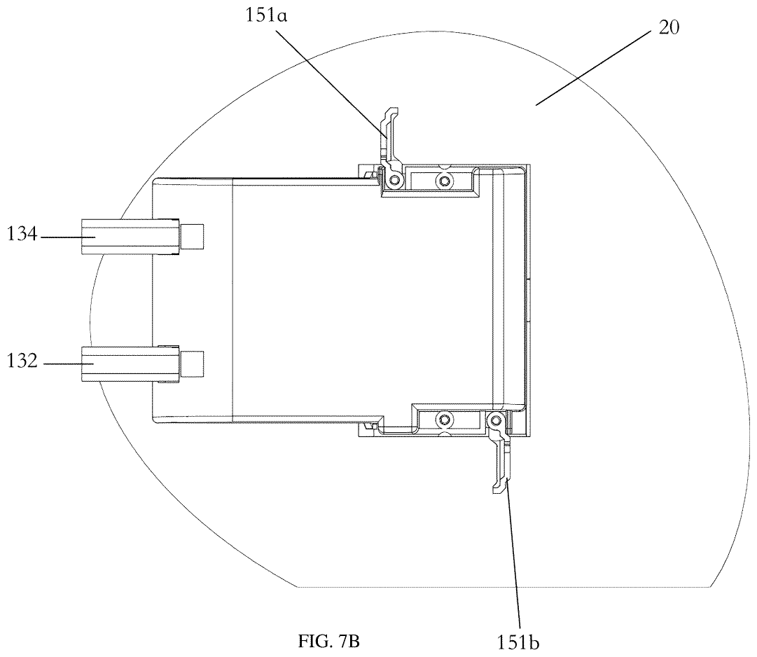

FIG. 6 schematically illustrates the installation of a receptacle device according to an embodiment of the present invention; FIGS. 7A and 7B are schematic front and back views of the receptacle device according to an embodiment of the present invention after it is installed on a wall panel. Referring to FIGS. 6, 7A, and 7B, the first end of the first external cable 132 and the first end of the second external cable 134 are first pulled out from behind the wall panel. Then, with the cover 16 removed, the first end of the first external cable 132 is inserted through the first through-hole 144 in the second shell 141, and the first end of the second external cable 134 is inserted through the second through-hole 145 in the second shell 141. Next, the first end of the first external cable 132 and the first end of the second external cable 134 are inserted into the other set (the one on the right in the figures) of the receiving slots 1432 of the piercing terminal assembly 143. The cover 16 is re-placed, and the first end of the first external cable 132 and the first end of the second external cable 134 are pressed into the piercing terminal assembly 143 using, for example, a lever mechanism, to form an electrical circuit with the power module 12. It should be understood that in other embodiments, a dedicated tool may be used to press the cables into the piercing terminal assembly 143. Finally, the receptacle device 10 is installed at the desired location of the target object, such as the space reserved for the receptacle device 10 on a wall panel. In some embodiments, the receptacle device 10 may be partially inserted into a rectangular hole 201 of the wall panel 20 from the back side and secured to the back side of the wall panel 20 using the hooks 151a and 151b. This prevents the receptacle device 10 from falling from the rear of the wall panel 20 due to gravity or other external forces, and also improves the stability of the receptacle device 10 in a mobile environment.

In some embodiments, to protect and/or decorate the power module 12, the receptacle device 10 may further include a faceplate 17. The faceplate 17 may be made of, for example, polycarbonate, or other materials with good electrical insulation, impact resistance, heat resistance, and flame retardancy. The faceplate 17 may be secured to the power module 12 and/or the first shell 11 via screws 154a and 154b. It should be understood that the securing method for faceplate 17 is not limited to screws; it may alternatively be secured to the power module 12 and/or the first shell 11 via snap fasteners or other suitable securing methods.

After installation, the power module 12 in the receptacle device 10 is coupled to the power supply terminal of the RV's internal power supply system. Connecting an electrical load to the output port (socket holes) of the power module 12 will provide power and ground fault protection to the electrical load. If the load terminal of the power module 12 is connected to a downstream receptacle through the receptacle device 10, power and ground fault protection can be provided to the downstream receptacle simultaneously.

FIG. 8 is an exploded view of a receptacle device according to another embodiment of the present invention. Compared to the embodiment shown in FIG. 4, this embodiment replaces the three sub-cables 131a, 131b, and 131c of the first conductor 131 with three conductive metal plates 131d, 131e, and 131f, which serve as the hot wire, neutral wire, and ground wire, respectively. Likewise, the three sub-cables 133a, 133b, and 133c of the second conductor 133 are replaced with three conductive metal plates 133d, 133e, and 133f, which serve as the hot wire, neutral wire, and ground wire, respectively. In one embodiment, the first ends of the three conductive metal plates 131d, 131e, and 131f of the first conductor 131 are respectively coupled to the hot wire input terminal, neutral wire input terminal, and ground wire input terminal of the power module 12, and their second ends are respectively integrally formed with the piercing terminal assembly 143. The first end of the sub-cable 133f used as the ground wire in the second conductor 133 may be electrically connected to the second end of the sub-cable 131f used as the ground wire in the first conductor 131 through the electrical connection module 14. The first ends of the sub-cables 133d and 133e used as the hot wire and the neutral wire in the second conductor 133 are respectively coupled to the hot load terminal and the neutral load terminal on the power module 12, and their second ends are respectively integrally formed with the piercing terminal assembly 143.

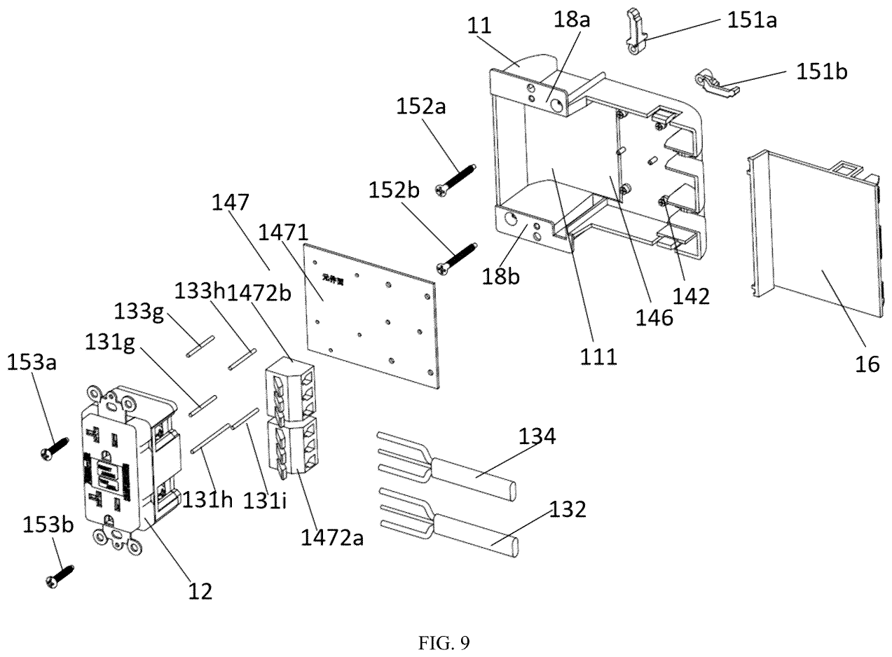

FIG. 9 is an exploded view of a receptacle device according to yet another embodiment of the present invention. Compared with the embodiment shown in FIG. 4, in this embodiment, the three sub-cables 131a, 131b and 131c of the first conductor 131 are replaced by three conductive pins 131g, 131h and 131i, which may be used as the hot wire, the neutral wire and the ground wire respectively; the three sub-cables 133a, 133b and 133c of the second conductor 133 are replaced by three conductive pins (only the first two of these pins 133g, 133h are shown), which can be used as the hot wire, the neutral wire and the ground wire respectively; and the piercing terminal assembly 143 of the electrical connection module 14 is replaced by a circuit board assembly 147. In one embodiment, the circuit board assembly 147 includes a circuit board 1471 and wiring terminal blocks 1472a and 1472b. The first ends of the three conductive pins 131g, 131h, and 131i of the first conductor 131 are respectively coupled to the hot wire input terminal, the neutral wire input terminal, and the ground wire input terminal of the power module 12, and their second ends are respectively coupled to the circuit board 1471. The first end of the conductive pin (not shown) used as the ground wire in the second conductor 133 may be electrically connected to the second end of the conductive pin 131i used as the ground wire in the first conductor 131 through the electrical connection module 14. The first ends of the conductive pins 133g, 133h used as the hot wire and the neutral wire in the second conductor 133 are respectively coupled to the hot load terminal and the neutral load terminal on the power module 12, and their second ends are respectively coupled to the circuit board 1471. The first ends of the terminal blocks 1472a and 1472b are respectively coupled to the circuit board 1471, and their second ends are respectively configured to connect to the first ends of the first external cable 132 and the second external cable 134. Conductive bars are provided on the circuit board 1471, to respectively provide electrical connections between the first conductor 131 and the first external cable 132, and between the second conductor 133 and the second external cable 134.

The receptacle device of various embodiments of the present invention can omit the height-extension panel, and can simplify the installation process of the power module in a small space by using the electrical connection module, thereby improving the user's installation efficiency and ensuring electrical safety during subsequent use.

While various embodiments are described above, the present invention is not limited to these embodiments. For those skilled in the art, the embodiments of the present application may have various changes and variations. Any modification, equivalent replacement, improvement, etc. made within the spirit and principle of the embodiment of the present application are within the scope of the present application.

Although the embodiments of the present application have been described, it should be understood that the present invention is not limited to the disclosed specific embodiments. The embodiments of the present application are intended to cover various modifications and equivalent arrangements included in the spirit and scope of the appended claims. The scope of the appended claims should be given the broadest reasonable interpretation, and cover all such modifications and equivalent structures and functions.

1. A receptacle device, comprising:
a first shell, having a first opening;
a power module, at least partially disposed in the first shell and configured to provide power output to an electrical device;
a first conductor, at least partially disposed in the first shell, wherein a first end of the first conductor is coupled to the power module; and
an electrical connection module, configured to electrically connect the first conductor and a first external cable.

2. The receptacle of claim 1, wherein the electrical connection module includes:
a second shell coupled to the first shell, the second shell having a second opening.

3. The receptacle of claim 2, wherein the electrical connection module further includes:
a bracket assembly, at least partially disposed in the second shell; and
a piercing terminal assembly, disposed on the bracket assembly and configured to electrically connect the first conductor and the first external cable.

4. The receptacle of claim 3, wherein the piercing terminal assembly includes a receiving slot configured to receive and pierce a second end of the first conductor and a first end of the first external cable to form an electrical connection between the first conductor and the first external cable.

5. The receptacle of claim 4, further comprising:
a cover plate, configured to cover the second opening of the second shell and to press the second end of the first conductor and the first end of the first external cable into the receiving slot of the piercing terminal assembly in response to an external force to cause the piercing terminal assembly to pierce the second end of the first conductor and the first end of the first external cable.

6. The receptacle of claim 3, wherein the piercing terminal assembly includes a receiving slot integrally formed with the first conductor, wherein the receiving slot is configured to receive and pierce a first end of the first external cable to electrically connect the first conductor and the first external cable.

7. The receptacle of claim 6, further comprising:
a cover plate, configured to cover the second opening of the second shell and to press the first end of the first external cable into the receiving slot of the piercing terminal assembly in response to an external force to cause the piercing terminal assembly to pierce the first end of the first external cable.

8. The receptacle of claim 3, wherein the bracket assembly includes a plurality of grooves, and the piercing terminal assembly includes a plurality of piercing terminals respectively inserted into the plurality of grooves.

9. The receptacle of claim 2, wherein the electrical connection module further includes:
a circuit board assembly, at least partially disposed in the second shell, configured to electrically connect the first conductor and the first external cable.

10. The receptacle of claim 9, wherein the circuit board assembly includes a circuit board and a wiring terminal block disposed on the circuit board, wherein a second end of the first conductor is coupled to the circuit board, a first end of the wiring terminal block is coupled to the circuit board, and a second end of the wiring terminal block is coupled to a first end of the first external cable.

11. The receptacle of claim 1, wherein the power module includes an electrical fault circuit interrupter, and wherein the first end of the first conductor is coupled to an input terminal of the electrical fault circuit interrupter.

12. The receptacle of claim 11, further comprising:
a second conductor, at least partially disposed within the first shell, wherein a first end of the second conductor is coupled to a load terminal of the electrical fault circuit interrupter, and
wherein the electrical connection module is further configured to receive a second end of the second conductor and a first end of a second external cable to electrically connect the second conductor and the second external cable.

13. The receptacle of claim 12, wherein the second shell has a first through hole and a second through hole, wherein the first through hole is configured to pass the first end of the first external cable through and into the second shell, and the second through hole is configured to pass the first end of the second external cable through and into the second shell.

14. The receptacle of claim 1, further comprising:
a panel covering the first opening of the first shell.

15. The receptacle of claim 1, further comprising:
a fixing assembly, disposed on the first shell and configured to affix the receptacle device to a target object when the receptacle device is mounted on the target object.

16. The receptacle of claim 1, wherein each of the first conductor and the first external cable include a hot wire, a neutral wire, and a ground wire.

17. A receptacle box, comprising:
a first shell having a first opening, the first shell configured to at least partially accommodate a power module and a first conductor, wherein a first end of the first conductor is coupled to the power module, and the power module is configured to provide power to an electrical device; and
an electrical connection module, configured to connect the first conductor to a first external cable.

18. The receptacle box of claim 17, wherein the electrical connection module includes:
a second shell coupled to the first shell, the second shell having a second opening;
a bracket assembly at least partially disposed within the second shell; and
a piercing terminal assembly disposed on the bracket assembly, configured to connect the first conductor and the first external cable.
